(19) United States
(12) Patent Application Publication
(10) Pub. No.: US 2005/0086322 A1
(43) Pub. Date: Apr. 21, 2005

(54) Upgrade system for software in electric home appliance

(76) Inventor: Joon-Bae Park, Changwon (KR)

Correspondence Address: Fleshner & Kim, PO Box 221200, Chantilly, VA, 20153-1200, US

(21) Appl. No.: 10/502,318

(22) PCT Filed: Jan. 28, 2003
(86) PCT No.: PCT/KR03/00197

(30) Foreign Application Priority Data
Jan. 28, 2002 (KR) 10-2002-0004893

(51) Int. Cl. G06F 15/16

(52) U.S. Cl. 709/217; 717/168

(57) ABSTRACT

A system for upgrading data of an electric home appliance, capable of analyzing and displaying data of a software on a display device by downloading the software of an updated electric home appliance using a computer system and upgrading the software of the electric home appliance by sensing the data displayed on the display device using a detector, thus to simplify the structure of the updating system and prevent generation of collision of hardware of the computer system as cables and communication ports for connecting respective electric home appliances and computer systems are not used.

### TECHNICAL FIELD

The present invention relates to a system for upgrading data of an electric home appliance and particularly, to a system for upgrading data of an electric home appliance, capable of transferring upgraded data to an electric home appliance without using a communication port of a computer system.

### BACKGROUND ART

Recently, an electric home appliance such as a refrigerator includes a communication device to connect to the Internet or to construct a home network. That is, since the electric home appliance is connected with a communication port of a computer system and receives a necessary software, upgrading of built-in softwares or internet searching can be performed.

A communication device of the electric home appliance in accordance with the conventional art will be described with reference to the accompanied drawings.

FIG. 1 is a view showing a system for upgrading data of an electric home appliance in accordance with the conventional art.

As shown in FIG. 1, the upgrading system includes an electric home appliance 100 which includes a communication port PORT1, a computer system 200 which can connect to the internal, download an update file of the electric home appliance 100 by connecting to a homepage of the manufacturing company of the electric home appliance 100 and includes a communication port PORT2, and a cable RS-232C which is connected with the communication ports PORT1 and PORT2, for functioning as a transmission path of data between the electric home appliance 100 and computer system 200.

The upgrading system with the above structure will be described in more detail.

A user adjusts the computer system 200 to upgrade a software of the electric home appliance 100, and downloads an update file corresponding to a model of the electric home appliance 100 by connecting to the homepage of the manufacturing company of the electric home appliance 100 or a mirror site.

The downloaded update file can be transmitted to the electric home appliance 100 through the cable RS-232C which connects the communication port PORT2 positioned in the computer system 200 and the communication port PORTI of the electric home appliance 100, and the electric home appliance 100 performs upgrading by using the upgrade file.

To connect the electric home appliance 100 and the computer system 200, communication ports must be included in the electric home appliance 100 and the computer system 200 respectively, and particularly, the computer system 200 must include cables which are connected a plurality of communication ports and respective electric home appliances to connect a plurality of electric home appliances.

However, in case of setting a plurality of communication ports in the computer system 200, the devices can collide with another devices. Also, by using a plurality of cables, the structure becomes complicated and defiles the appearance.

### DETAILED DESCRIPTION OF THE INVENTION

Therefore, an object of the present invention is to provide a system for upgrading data of an electric home appliance, capable of upgrading a software of an electric home appliance by detecting data of an update file displayed on a display device without installing an additional communication port for performing communication with respective electric home appliance in the computer system.

Also, the other object of the present invention is to provide a system for upgrading data of an electric home appliance, capable of improving appearance and simplifying the structure by excluding usage of RS-232C cable for connecting the respective electric home appliances and computer system.

To achieve these and other advantages and in accordance with the purpose of the present invention, as embodied and broadly described herein, there is provided a system for upgrading data of an electric home appliance, including an electric home appliance having a microcomputer built-in, a computer system for displaying data for updating the microcomputer of the electric home appliance on a display device by connecting to the internet and a detector which is connected with the electric home appliance, for reading the data displayed on the display device and applying the data to the electric home appliance.

### BRIEF DESCRIPTION OF THE DRAWINGS

FIG. 1 is a view showing structure of a system for upgrading data of an electric home appliance in accordance with the conventional art; and

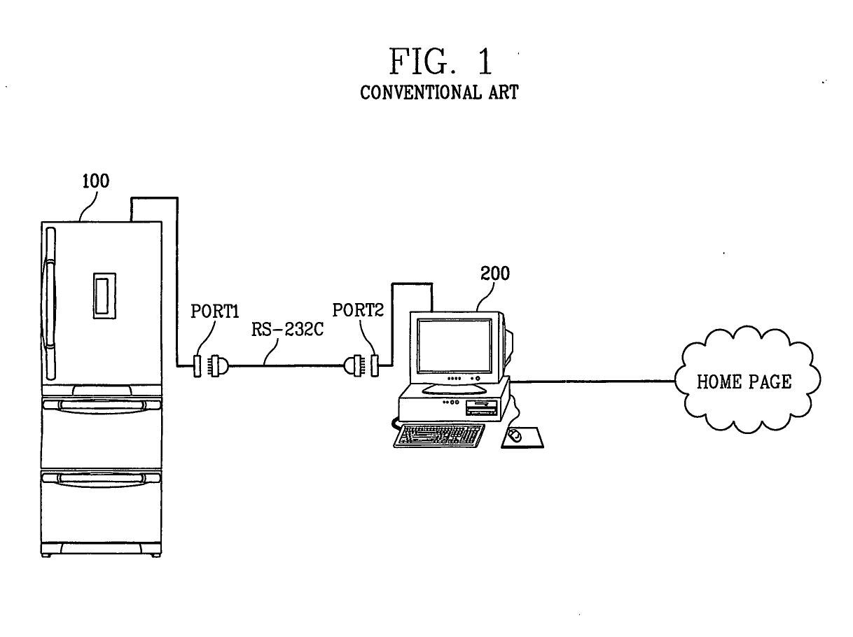

FIG. 2 is a view showing structure of a system for upgrading data of an electric home appliance in accordance with the present invention.

### MODE FOR CARRYING OUT THE PREFERRED EMBODIMENTS

The present invention will now be described with reference to accompanying drawings.

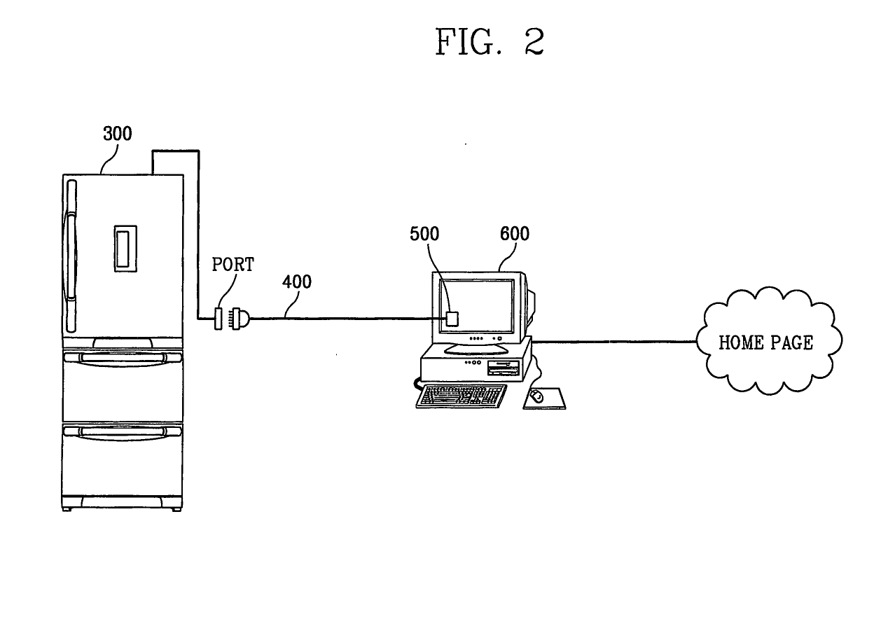

FIG. 2 is a view showing structure of a system for upgrading data of an electric home appliance in accordance with the present invention.

As shown in FIG. 2, the upgrade system includes an electric home appliance 300 having a communication port PORT, a computer system 600 which can be connected to the internet, performs downloading of update data of the electric home appliance 300 by connecting to a homepage of a manufacturing company of the electric home appliance 300 and displays the data as two colors of black and white, a detector 500 for detecting the data of the update file which is displayed on the display device of the computer system and a cable 400 for applying the result detected by the detector 500 to the communication port PORT of the electric home appliance 300.

The present invention with the above structure will be described in more detail.

Firstly, the user connects to the homepage of the manufacturing company of the electric home appliance 300 by using the computer system 600 to upgrade a software of the electric home appliance 300, and then performs downloading of an update file corresponding to the electric home appliance 300 from the homepage of the manufacturing company of the electric home appliance 300.

The downloaded file is analyzed in the computer system 600 and displayed as black and white by a data display device. That is, the binary data is displayed by analyzing the data a black and white colors. This can be done by analyzing data of the update software of the electric home appliance downloaded to the computer system 600 and performing setup of the software which can display the result as black and white colors.

Then, the user attaches a detector 500 which is positioned at the other end of the cable having an end which is connected to the communication port PORT of the electric home appliance 300 on a screen of the display device under the condition that the data of the update file is displayed on the display device of the computer system 600. When the detector 500 is attached on the display device, the detector 500 detects the data of the update file displayed on the display device and generates an electric signal corresponding to the data.

Thereafter, when the data of the update file displayed as black and white on the display device of the computer system 600 is transmitted to the electric home appliance 300 by recognizing the data, the electric home appliance 300 which has the protocol capable of analyzing the signal built-in performs upgrading of the software by analyzing the data of the update file applied through the detector 500.

The upgrading device in accordance with the present invention can upgrade a software of the electric home appliance 300 by detecting data of an update file displayed on a display device without installing an additional communication port for performing communication with respective electric home appliance 300 in the computer system 600.

Also, the present invention can improve appearance and simplify the structure by excluding usage of RS-232C cable for connecting the respective electric home appliance 300 and computer system 600.

### INDUSTRIAL APPLICABILITY

The system for upgrading data of an electric home appliance in accordance with the present invention displays data of the software by analyzing the data as black and white by downloading the software of the electric home appliance which is updated by using the computer system and upgrades the software of the electric home appliance by detecting the data displayed on the display device, thus to simplify structure of the update system and prevent generation of collision of hardware in the computer system as cables and communication ports for connecting the respective electric home appliance and computer system are not used.

1. A system for upgrading data of an electric home appliance, comprising:
an electric home appliance having a microcomputer built-in;
a computer system for displaying data for updating the microcomputer of the electric home appliance on a display device by connecting to the internet; and
a detector which is connected with the electric home appliance, for reading the data displayed on the display device and applying the data to the electric home appliance.

2. The system of claim 1, wherein the electric home appliance has a protocol for analyzing the data applied in the detector built-in.

3. The system of claim 1, wherein the computer system displays the data on the display device with colors.

4. The system of claim 3, wherein the colors are displayed on the display device as black and white.

5. The system of claim 1, wherein the detector reads the data displayed on the display device as colors.

6. The system of claim 5, wherein the colors are displayed on the display device as black and white.

7. A system for upgrading data of an electric home appliance, comprising:
an electric home appliance having a communication port, which can upgrade functions of a built-in microcomputer;
a computer system which performs downloading of update data of the electric home appliance by connecting to the internet and displays the data as two colors of black and white; and
a detector which is connected with the communication port of the electric home appliance with a cable, for applying the data to the electric home appliance by detecting the black and white data displayed on the display device of the computer system.

8. The system of claim 7, wherein the electric home appliance has a protocol for analyzing the data applied in the detector built-in.
